(19) United States
(12) Patent Application Publication
(10) Pub. No.: US 2023/0049277 A1
(43) Pub. Date: Feb. 16, 2023

(54) METHOD AND APPARATUS FOR PROVIDING UPLINK SIGNAL-BASED LOCATION SERVICE

(71) Applicant: Samsung Electronics Co., Ltd., Suwon-si (KR)

(72) Inventors: Taeseop LEE, Suwon-si (KR); Seungri JIN, Suwon-si (KR)

(21) Appl. No.: 17/871,416

(22) Filed: Jul. 22, 2022

(30) Foreign Application Priority Data
Jul. 30, 2021 (KR) 10-2021-0100474

(51) Int. Cl. H04W 64/00; H04L 5/00; G01S 5/02; G01S 5/00

(52) U.S. Cl. CPC H04W 64/003; H04L 5/0048; G01S 5/0236; G01S 5/0027; G01S 5/0242

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). A wireless communication system is provided. The wireless communication system includes a location management function (LMF) that may efficiently determine and provide information necessary for a base station to configure a sounding reference signal (SRS) transmission resource required for a terminal.

### CROSS-REFERENCE TO RELATED APPLICATION(S)

This application is based on and claims priority under 35 U.S.C. § 119(a) of a Korean patent application number 10-2021-0100474, filed on Jul. 30, 2021, in the Korean Intellectual Property Office, the disclosure of which is incorporated by reference herein in its entirety.

### BACKGROUND

### 1. Field

The disclosure relates to a method and apparatus for providing a location service in a wireless communication system.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

In a case where it is necessary to transmit an uplink sounding reference signal (SRS) of a target terminal when performing a positioning service in a next-generation communication system, a location management function (LMF) may request a serving gNB to configure an SRS transmission resource of the corresponding terminal. In this case, the LMF delivers information on the SRS resource requested according to the NR positioning protocol A (NRPPa) standard to the serving gNB, the serving gNB finally determines the SRS resource to be configured for the UE and then allocates the SRS resource to the UE via RRC signaling.

According to the current NRPPa standard, when the LMF requests the serving gNB to configure the SRS transmission resource of the target UE, there is a difficulty in configuring spatial relation information (information indicating the beam direction when transmitting SRS) of the SRS transmission resource by the serving gNB based on the information.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wireless communication system, the location management function (LMF) requests the serving base station (e.g., gNB) to configure the sounding reference signal (SRS) transmission resource of the location estimation target terminal, and based on this, the serving base station (e.g., gNB) determines the SRS transmission resource required for the UE and provides a selection method and apparatus.

Another aspect of the disclosure is to provide a method and apparatus for clarifying the corresponding relation between SRS transmission resources and spatial relation information.

Additional aspects will be set forth in part in the description which follows and, in part, will be apparent from the description, or may be learned by practice of the presented embodiments.

In accordance with an aspect of the disclosure, a method performed by a location management function (LMF) entity in a wireless communication system is provided. The method includes identifying spatial relation information per a sounding reference signal (SRS) resource, transmitting, to a base station, a request message for a positioning including information on the SRS resource, wherein the information on the SRS resource includes the identified spatial relation information for the SRS resource, and receiving, from the base station, a response message including a SRS resource configuration information determined based on the request message for the positioning.

In accordance with another aspect of the disclosure, a method performed by a base station in a wireless communication system is provided. The method includes receiving, from a location management function (LMF) entity, a request message for a positioning including information on a SRS resource, wherein spatial relation information is identified per the SRS resource, and the information on the SRS resource includes the spatial relation information for the SRS resource, and transmitting, to the LMF entity, a response message including a SRS resource configuration information determined based on the request message for the positioning.

In accordance with another aspect of the disclosure, a location management function (LMF) entity in a wireless communication system is provided. The LMF entity includes a transceiver, and at least one processor configured to identify spatial relation information per a SRS resource, transmit, to a base station via the transceiver, a request message for a positioning including information on the SRS resource, wherein the information on the SRS resource includes the identified spatial relation information for the SRS resource, and receive, from the base station via the transceiver, a response message including a SRS resource configuration information determined based on the request message for the positioning.

In accordance with another aspect of the disclosure, a base station in a wireless communication system is provided. The base station includes a transceiver, and at least one processor configured to receive, from a location management function (LMF) entity via the transceiver, a request message for a positioning including information on a SRS resource, wherein spatial relation information is identified per the SRS resource, and the information on the SRS resource includes the spatial relation information for the SRS resource, and transmit, to the LMF entity via the transceiver, a response message including a SRS resource configuration information determined based on the request message for the positioning.

The method and apparatus according to embodiments of the disclosure may determine and select a sounding reference signal (SRS) transmission resource required for a terminal in a wireless communication system.

In addition, in the method and apparatus according to embodiments of the disclosure, a location management function (LMS) in a wireless communication system may provide optimal beam direction information for each SRS transmission resource to a base station.

In addition, the method and apparatus according to the embodiments of the disclosure may reduce the computational complexity of the base station by clarifying the corresponding relation of spatial relation information for each SRS transmission resource in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a next-generation mobile communication system according to an embodiment of the disclosure;

FIG. 2 is a diagram illustrating a network structure for providing a terminal location service (LoCation Service, hereinafter referred to as LCS) in a next-generation mobile communication system according to an embodiment of the disclosure;

FIG. 3 is a flowchart of a process of performing LCS in a next-generation mobile communication system according to an embodiment of the disclosure;

FIG. 4 is a flowchart of a process of exchanging a detailed LPP message in the UE procedure step in FIG. 3 according to an embodiment of the disclosure;

FIG. 5 is a flowchart illustrating a detailed message exchange process for configuring a sounding reference signal (SRS) resource of a UE during operation of a UL positioning method (e.g., UL-TDOA and UL-AOA) and a DL+UL positioning method (e.g., Multi-RTT) according to an embodiment of the disclosure;

FIG. 6 is a diagram illustrating information delivered between an, a serving gNB, and a UE for configuring transmission of a sounding reference signal (SRS) of the UE according to an embodiment of the disclosure;

FIG. 7 is a diagram briefly illustrating SRS-related request configuration information included in a Requested SRS configuration delivered by a LMF to the serving gNB in FIG. 6 according to an embodiment of the disclosure;

FIG. 8A is a diagram illustrating an NRPPa standard proposal for supporting configuration of a single spatial relation per SRS resource unit according to an embodiment of the disclosure;

FIG. 8B is a diagram illustrating an NRPPa standard proposal for supporting configuration of a single spatial relation per SRS resource unit according to an embodiment of the disclosure;

FIG. 9A is a diagram illustrating an NRPPa standard proposal for supporting configuration of multiple spatial relation per SRS resource unit according to an embodiment of the disclosure;

FIG. 9B is a diagram illustrating an NRPPa standard proposal for supporting configuration of multiple spatial relation per SRS resource unit according to an embodiment of the disclosure;

FIG. 10 is a flowchart illustrating a process in which a serving gNB configures SRS based on SRS resource request information received from an LMF according to an embodiment of the disclosure;

FIG. 11 illustrates a configuration of a network node according to an embodiment of the disclosure;

FIG. 12 illustrates a configuration of a base station according to an embodiment of the disclosure; and

FIG. 13 illustrates a configuration of a terminal according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, the disclosure will be described using terms and names defined in the 3rd generation partnership project long term evolution (3GPP LTE) standards for the convenience of description. However, the disclosure is not limited by these terms and names, and may be applied in the same way to systems that conform other standards. In the disclosure, the term “eNB” may be interchangeably used with the term “gNB”. That is, a base station described as “eNB” may indicate “gNB”.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto.

In the following description of embodiments of the disclosure, LTE, LTE advanced (LTE-A), LTE Pro, or 5G (or new radio (NR), next-generation mobile communication) systems will be described by way of example, but the embodiments of the disclosure may be applied to other communication systems having similar backgrounds or channel types. Further, based on determinations by those skilled in the art, the embodiments of the disclosure may be applied to other communication systems through some modifications without significantly departing from the scope of the disclosure.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

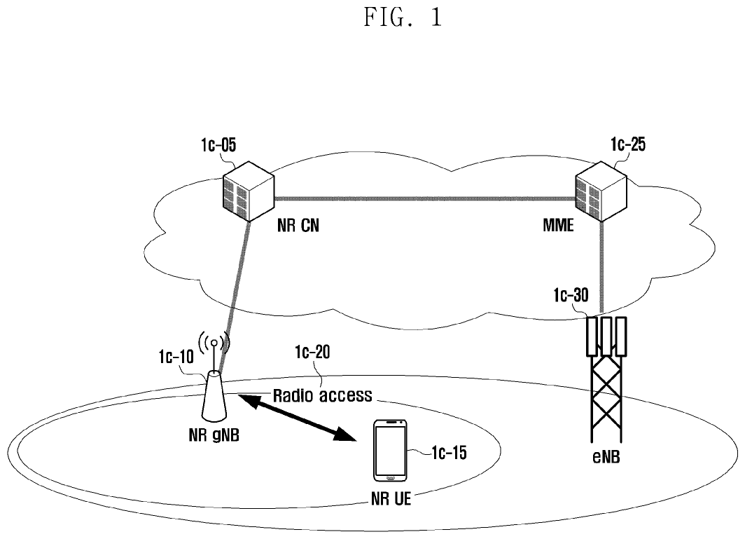

FIG. 1 is a diagram illustrating a structure of a next-generation mobile communication system according to an embodiment of the disclosure.

Referring to FIG. 1, as illustrated, a radio access network of a next-generation mobile communication system (hereinafter NR or 5G) may include a next-generation base station (New Radio Node B, hereinafter NR NB, gNB, NR gNB, or NR base station) 1c-10 and a new radio core network (NR CN) 1c-05. It is not limited to the above example, and the radio access network of the next-generation mobile communication system may include more entities. A new radio user equipment (hereinafter NR UE or terminal) 1c-15 may access an external network via NR gNB 1c-10 and NR CN 1c-05.

In FIG. 1, the NR gNB 1c-10 corresponds to an Evolved Node B (eNB) of an existing LTE system. The NR gNB 1c-10 is connected to the NR UE 1c-15 via a radio channel 1c-20 and may provide a service superior to that of the existing Node B. In the next-generation mobile communication system, because all user traffic is provided via the shared channel, a device for scheduling by collecting status information such as buffer status, available transmission power status, and channel status of the UEs is required, and the NR gNB 1c-10 is responsible for this. One NR gNB 1c-10 may control multiple cells.

According to an embodiment of the disclosure, in order to implement ultra-high-speed data transmission compared to the LTE system, the next-generation mobile communication system may have a bandwidth greater than or equal to the existing maximum bandwidth, and may provide an additional beamforming technology by using orthogonal frequency division multiplexing (OFDM) as a radio access technology. In addition, the next-generation mobile communication system may use an adaptive modulation & coding (AMC) method that determines a modulation scheme and a channel coding rate according to the channel state of the UE. The NR CN 1c-05 may perform functions such as mobility support, bearer configuration, QoS configuration, and the like. The NR CN 1c-05 is a device in charge of various control functions as well as a mobility management function for the UE, and may be connected to a plurality of base stations. In addition, the next-generation mobile communication system may be linked with the existing LTE system, and the NR CN 1c-05 may be connected to the MME 1c-25 via a network interface. The MME may be connected to the existing base station eNB 1c-30.

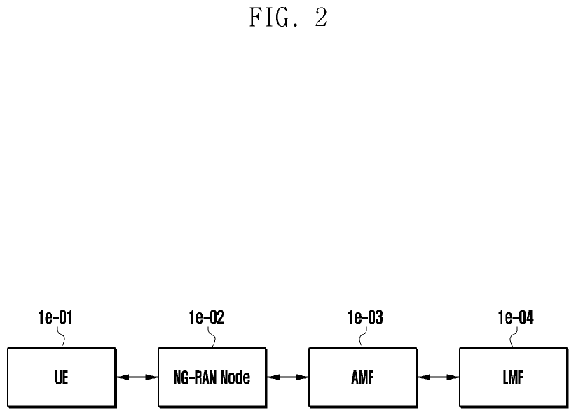

FIG. 2 is a diagram illustrating a network structure for providing a terminal location service (LoCation Service, hereinafter referred to as LCS) in a next-generation mobile communication system according to an embodiment of the disclosure.

Referring to FIG. 2, a network for providing LCS in a next-generation mobile communication system includes a terminal 1e-01, a base station (NG-RAN Node) 1e-02, access and mobility function (AMF) 1e-03, and location management function (LMF) 1e-04. In this case, the terminal 1e-01 communicates with the LMF 1e-04 via the base station 1e-02 and the AMF 1e-03, and exchanges information required for location estimation. The role of each component to provide LCS is as follows.

The terminal 1e-01 may perform a role of measuring a radio signal required for location estimation and transmitting the result to the LMF 1e-04.

The base station 1e-02 may perform a role of transmitting a downlink radio signal required for location estimation and measuring an uplink radio signal transmitted from a target terminal, and the like.

The AMF 1e-03 may perform a role of instructing the provision of a location providing service by delivering an LCS request message to the LMF 1e-04 after receiving the LCS request message from the LCS requester. When the LMF 1e-04 responds to the location estimation result of the terminal after processing the location estimation request, the AMF 1e-03 may deliver the corresponding result to the LCS requester.

The LMF (1e-04) is a device that receives and processes the LCS request from the AMF 1e-03, and may perform a role of controlling the overall process required for location estimation. For terminal location estimation, the LMF 1e-04 provides auxiliary information necessary for location estimation and signal measurement to the terminal 1e-01 and receives the result, in this case LTE positioning protocol (LPP) may be used as the protocol for data exchange. The LPP may define a message standard exchanged between the terminal 1e-01 and the LMF 1e-04 for the location service. In addition, the LMF 1e-04 may transmit and receive downlink reference signal (positioning reference signal, hereinafter referred to as PRS) configuration information and uplink reference signal (sounding reference signal, hereinafter referred to as SRS) measurement results to be used for location estimation with the base station 1e-02. In this case, NR positioning protocol A (NRPPa) may be used as a protocol for data exchange, and NRPPa may define a message standard exchanged between the base station 1e-02 and the LMF 1e-04.

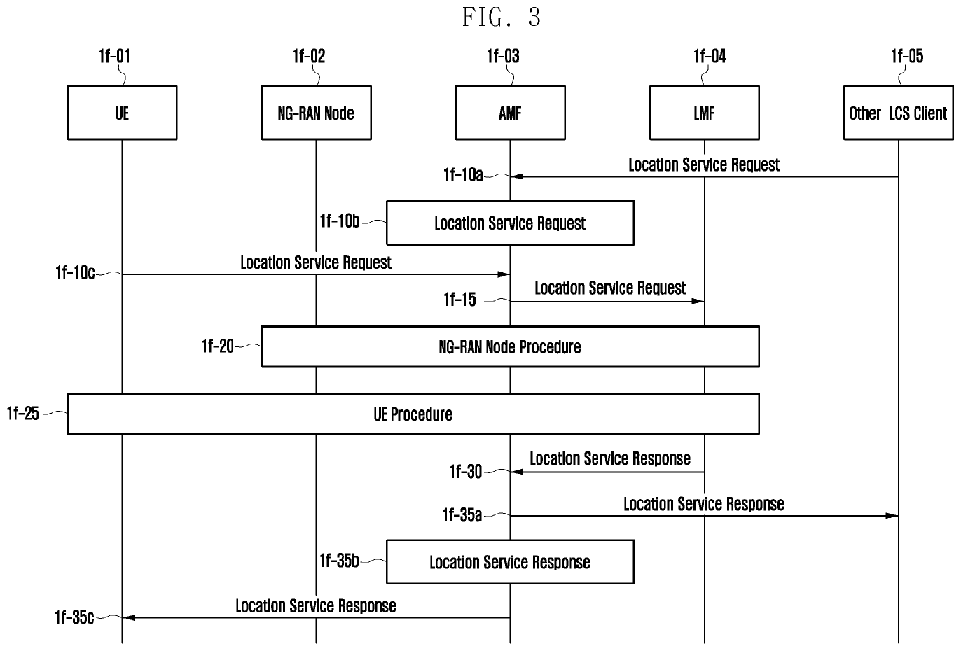

FIG. 3 is a flowchart of a process of performing LCS in a next-generation mobile communication system according to an embodiment of the disclosure.

Referring to FIG. 3, after receiving the LCS request 1f-10a/1f-10b/1f-10c, the AMF 1f-03 may deliver the request to the LMF 1f-04. Thereafter, the LMF 1f-04 may control the process of exchanging the required information with the terminal and the base station to process the LCS request 1f-10a/1f-10b/1f-10c, and transmit the result value (location estimation result) to the AMF 1f-03. Performing LCS may be completed by the AMF 1f-03 delivering the result value to the target that requested the LCS. There are 3 types of LCS requests received by AMF 1f-03 in step 1f-10.

1. LCS request 1f-10a received from external LCS client 1f-05 by

2. LCS request 1f-10b generated by AMF 1f-03 itself

3. LCS request 1f-10c received from UE 1f-01

After receiving one of the three types of LCS requests, the AMF 1f-03 may request the LMF 1f-04 to provide a location service by transmitting a location service request message 1f-15. Thereafter, in the NG-RAN Node procedure step 1f-20, the LMF 1f-04 may perform a procedure (e.g., configuring the base station PRS, securing the base station SRS measurement information, etc.) required for location estimation via an NRPPa message exchange with the NG-RAN Node 1f-02. In addition, in the UE procedure step 1f-25, the LMF 1f-04 may exchange an LPP message to exchange required information with the terminal 1f-01. Via the above process, the LMF 1f-04 may perform procedures such as exchanging UE capability information related to location estimation, transmitting auxiliary information for signal measurement of the terminal, requesting and obtaining a terminal measurement result. When the LMF 1f-04 determines the estimated location of the terminal based on various measurement results obtained, the LMF 1f-04 may deliver a location service response message 1f-30 to the AMF 1f-03. The AMF 1f-03 may deliver the LCS response message 1f-35a/1f-35b/1f-35c to the target that requested the LCS, and the LCS response message 1f-35a/1f-35b/1f-35c may include a UE location estimation result.

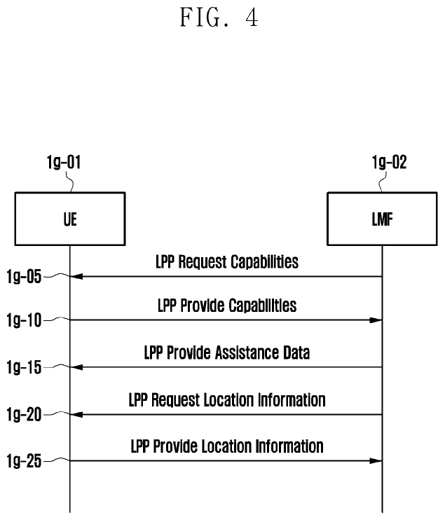

FIG. 4 is a flowchart of a process of exchanging a detailed LPP message in the UE procedure step in FIG. 3 according to an embodiment of the disclosure.

Referring to FIG. 4, a process in which the LMF 1g-02 exchanges terminal capability (hereinafter referred to as UE Capability) information related to location estimation with the terminal 1g-01, delivers auxiliary information for signal measurement of the terminal, requests and obtains a terminal measurement result, etc. is illustrated. The usage and definition of each LPP message sent and received at each step are as follows.

LPP Request Capabilities (LMF→UE, 1g-05)

: May be used by the LMF 1g-02 to request UE capability information related to location estimation from the terminal 1g-01. Information included in the message may be defined as illustrated in Table 1 below. The request for common information regardless of the location estimation method (e.g., global navigation satellite system (GNSS), observed time difference of arrival (OTDOA), enhanced cell ID (ECID), etc.) is included in CommonIEsRequestCapabilities, and a request for additionally required information for each location estimation method may be included in a separate information element (IE) for each method.

```
TABLE 1
RequestCapabilities ::= SEQUENCE {
  criticalExtensions CHOICE {
      c1 CHOICE {
          requestCapabilities-r9 RequestCapabilities-r9-IEs,
          spare3 NULL, spare2 NULL, spare1 NULL
      },
      criticalExtensionsFuture  SEQUENCE { }
  }
}
RequestCapabilities-r9-IEs ::= SEQUENCE {
```

| commonIEsRequestCapabilities | CommonIEsRequestCapabilities | OPTIONAL, | -- Need ON |
|---|---|---|---|
| a-gnss-RequestCapabilities | A-GNSS-RequestCapabilities | OPTIONAL, | -- Need ON |
| otdoa-RequestCapabilities | OTDOA-RequestCapabilities | OPTIONAL, | -- Need ON |
| ecid-RequestCapabilities | ECID-RequestCapabilities | OPTIONAL, | -- Need ON |
| epdu-RequestCapabilities | EPDU-Sequence | OPTIONAL, | -- Need ON |
| ..., | | | |
| [[ sensor-RequestCapabilities-r13 | Sensor-RequestCapabilities-r13 | OPTIONAL, | -- Need ON |
| tbs-RequestCapabilities-r13 | TBS-RequestCapabilities-r13 | OPTIONAL, | -- Need ON |
| wlan-RequestCapabilities-r13 | WLAN-RequestCapabilities-r13 | OPTIONAL, | -- Need ON |
| bt-RequestCapabilities-r13 | BT-RequestCapabilities-r13 | OPTIONAL | -- Need ON |
| ]], | | | |
| [[ nr-ECID-RequestCapabilities-r16 | NR-ECID-RequestCapabilities-r16 | OPTIONAL, | -- Need ON |
| nr-Multi-RTT-RequestCapabilities-r16 | | | |
| | NR-Multi-RTT-RequestCapabilities-r16 | | |
| | | OPTIONAL, | -- Need ON |
| nr-DL-AoD-RequestCapabilities-r16 | | | |
| | NR-DL-AoD-RequestCapabilities-r16 | OPTIONAL, | -- Need ON |
| nr-DL-TDOA-RequestCapabilities-r16 | | | |
| | NR-DL-TDOA-RequestCapabilities-r16 | OPTIONAL, | -- Need ON |
| nr-UL-RequestCapabilities-r16 | NR-UL-RequestCapabilities-r16 | OPTIONAL | -- Need ON |
| ]] | | | |
| } | | | |

LPP Provide Capabilities (UE→LMF, 1g-10)

: May be used by the terminal 1g-01 to deliver UE capability information requested from the LMF 1g-02. Information included in the message may be defined as illustrated in Table 2 below. Similar to the LPP request capabilities message, common information regardless of the location estimation method may be included in commonIEsProvideCapabilities, and information requested for each location estimation method may be included in separate IEs.

```
TABLE 2
ProvideCapabilities ::= SEQUENCE {
  criticalExtensions CHOICE {
      c1 CHOICE {
          provideCapabilities-r9  ProvideCapabilities-r9-IEs,
          spare3 NULL, spare2 NULL, spare1 NULL
      },
      criticalExtensionsFuture  SESEQUENCE { }
  }
}
```

| ProvideCapabilities-r9-IEs ::= SEQUENCE { | | |
|---|---|---|
| commonIEsProvideCapabilities | CommonEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |
| ..., | | |
| [[ sensor-ProvideCapabilities-r13 | Sensor-ProvideCapabilities-r13 | OPTIONAL, |
| tbs-ProvideCapabilities-r13 | TBS-ProvideCapabilities-r13 | OPTIONAL, |
| wlan-ProvideCapabilities-r13 | WLAN-ProvideCapabilities-r13 | OPTIONAL, |
| bt-ProvideCapabilities-r13 | BT-ProvideCapabilities-r13 | OPTIONAL |
| ]], | | |
| [[ nr-ECID-ProvideCapabilities-r16 | NR-ECID-ProvideCapabilities-r16 | OPTIONAL, |
| nr-Multi-RTT-ProvideCapabilities-r16 | | |
| | NR-Multi-RTT-ProvideCapabilities-r16 | OPTIONAL, |
| nr-DL-AoD-ProvideCapabilities-r16 | | |
| | NR-DL-AoD-ProvideCapabilities-r16 | OPTIONAL, |
| nr-DL-TDOA-ProvideCapabilities-r16 | | |
| | NR-DL-TDOA-ProvideCapabilities-r16 | OPTIONAL, |
| nr-UL-ProvideCapabilities-r16 | NR-UL-ProvideCapabilities-r16 | OPTIONAL |
| ]] | | |
| } | | |

LPP ProvideAssistanceData (LMF→UE, 1g-15)

: May be used to make the LMF 1g-02 provide information required or helpful for the terminal 1g-01 to perform radio signal measurement for location estimation. Information included in the message may be defined as illustrated in Table 3 below.

```
TABLE 3
ProvideAssistanceData ::= SEQUENCE {
  criticalExtensions  CHOICE {
      c1 CHOICE {
          provideAssistanceData-r9  ProvideAssistanceData-r9-IEs,
          spare3 NULL, spare2 NULL, spare1 NULL
      },
      criticalExtensionsFuture  SEQUENCE { }
  }
}
ProvideAssistanceData-r9-IEs ::= SEQUENCE {
```

| commonEsProvideAssistanceData | CommonIEsProvideAssistanceData | OPTIONAL, | -- Need ON |
|---|---|---|---|
| a-gnss-ProvideAssistanceData | A-GNSS-ProvideAssistanceData | OPTIONAL, | -- Need ON |
| otdoa-ProvideAssistanceData | OTDOA-ProvideAssistanceData | OPTIONAL, | -- Need ON |
| epdu-Provide-Assistance-Data | EPDU-Sequence | OPTIONAL, | -- Need ON |
| ..., | | | |
| [[ | | | |
| sensor-ProvideAssistanceData-r14 | Sensor-ProvideAssistanceData-r14 | OPTIONAL, | -- Need ON |
| tbs-ProvideAssistanceData-r14 | TBS-ProvideAssistanceData-r14 | OPTIONAL, | -- Need ON |
| wlan-ProvideAssistanceData-r14 | WLAN-ProvideAssistanceData-r14 | OPTIONAL | -- Need ON |
| ]], | | | |
| [[ nr-Multi-RTT-ProvideAssistanceData-r16 | | | |
| | NR-Multi-RTT-ProvideAssistanceData-r16 | | |
| | | OPTIONAL, | -- Need ON |
| nr-DL-AoD-ProvideAssistanceData-r16 | | | |
| | NR-DL-AoD-ProvideAssistanceData-r16 | OPTIONAL, | -- Need ON |
| nr-DL-TDOA-ProvideAssistanceData-r16 | | | |
| | NR-DL-TDOA-ProvideAssistanceData-r16 | | |
| | | OPTIONAL | -- Need ON |
| ]] | | | |
| } | | | |

LPP Request Location Information (LMF→UE, 1g-20)

: May be used by the LMF 1g-02 to request the terminal 1g-01 to measure a signal required for location estimation and to request a location estimation result. After determining which location estimation method to use, what measurement the terminal should perform for the location estimation method, what result and how to respond, etc., the LMF 1g-02 may transmit related information to the terminal 1g-01 by including the related information in this message. Information included in the message may be defined as illustrated in Table 4 below.

```
TABLE 4
RequestLocationInformation ::= SEQUENCE {
  criticalExtensions  CHOICE {
      c1 CHOICE {
          requestLocationInformation-r9  RequestLocationInformation-r9-IEs,
          spare3 NULL, spare2 NULL, spare1 NULL
      },
      criticalExtensionsFuture  SEQUENCE { }
  }
}
RequestLocationInformation-r9-IEs ::= SEQUENCE {
  commonIEsRequestLocationInformation
```

| | | | |
|---|---|---|---|
| | CommonIEsRequestLocationInformation | OPTIONAL, | -- Need ON |
| a-gnss-RequestLocationInformation | A-GNSS-RequestLocationInformation | OPTIONAL, | -- Need ON |
| otdoa-RequestLocationInformation | OTDOA-RequestLocationInformation | OPTIONAL, | -- Need ON |
| ecid-RequestLocationInformation | ECID-RequestLocationInformation | OPTIONAL, | -- Need ON |
| epdu-RequestLocationInformation | EPDU-Sequence | OPTIONAL, | -- Need ON |
| ..., | | | |
| [[ | | | |

sensor-RequestLocationInformation-r13

| | Sensor-HequestLocationInformation-r13 | | |
|---|---|---|---|
| | | OPTIONAL, | -- Need ON |
| tbs-RequestLocationInformation-r13 | TBS-RequestLocationInformation-r13 | OPTIONAL, | -- Need ON |
| wlan-RequestLocationInformation-r13 | WLAN-RequestLocationInformation-r13 | OPTIONAL, | -- Need ON |
| bt-RequestLocationInformation-r13 | BT-RequestLocationInformation-r13 | OPTIONAL | -- Need ON |
| ]], | | | |
| [[ nr-ECID-RequestLocationInformation-r16 | | | |
| | NR-ECID-RequestLocationInformation-r16 | | |
| | | OPTIONAL, | -- Need ON |
| nr-Multi-RTT-RequestLocationInformation-r16 | | | |
| | NR-Multi-RTT-RequestLocationInformation-r16 | | |
| | | OPTIONAL, | -- Need ON |
| nr-DL-AoD-RequestLocationInforroation-r16 | | | |
| | NR-DL-AoD-RequestLocationInformation-r16 | | |
| | | OPTIONAL, | -- Need ON |
| nr-DL-TDOA-RequestLocationInformation-r16 | | | |
| | NR-DL-TDOA-RequestLocationInformation-r16 | | |
| | | OPTIONAL | -- Need ON |
| ]] | | | |
| } | | | |

LPP Provide Location Information (UE→LMF, 1g-25)

: May be used by the UE to deliver the measurement result and location estimation result requested from the terminal 1g-01 to the LMF 1g-02. Information included in the message may be defined as illustrated in Table 5 below.

```
TABLE 5
ProvideLocationInformation ::= SEQUENCE {
  criticalExtensions CHOICE {
      c1 CHOICE {
          provideLocationInformation-r9  ProvideLocationInformation-r9-IEs,
          spare3 NULL, spare2 NULL, spare1 NULL
      },
      criticalExtensionsFuture  SEQUENCE { }
  }
}
ProvideLocationInformation-r9-IEs ::= SEQUENCE {
  commonIEsProvideLocationInformation
```

| | CommonIEsProvideLocationInformation | OPTIONAL, |
|---|---|---|
| a-gnss-ProvideLocationInformation | A-GNSS-ProvideLocationInformation | OPTIONAL, |
| otdoa-ProvideLocationInformation | OTDOA-ProvideLocationInformation | OPTIONAL, |
| ecid-ProvideLocationInformation | ECID-ProvideLocationInformation | OPTIONAL, |
| epdu-ProvideLocationInformation | EPDU-Sequence | OPTIONAL, |
| ..., | | |
| [[ | | |
| sensor-ProvideLocationInformation-r13 | | |
| | Sensor-ProvideLocationInformation-r13 | |
| | | OPTIONAL, |
| tbs-ProvideLocationInformation-r13 | TBS-ProvideLocationInformation-r13 | OPTIONAL, |
| wlan-ProvideLocationInformation-r13 | WLAN-ProvideLocationInformation-r13 | OPTIONAL, |
| bt-ProvideLocationInformation-r13 | BT-ProvideLocationInformation-r13 | OPTIONAL |
| ]], | | |
| [[ nr-ECID-ProvideLocationInformation-r16 | | |
| | NR-ECID-ProvideLocationInformation-r16 | OPTIONAL, |
| nr-Multi-RTT-ProvideLocationInformation-r16 | | |
| | NR-Multi-RTT-ProvideLocationInformation-r16 | OPTIONAL, |
| nr-DL-AoD-ProvideLocationInformation*r16 | | |
| | NR-DL-AoD-ProvideLocationInformation-r16 | OPTIONAL, |
| nr-DL-TD0A-ProvideLocationInformation-r16 | | |
| | NR-DL-TDOA-ProvideLocationInformation-r16 | OPTIONAL |
| ]] | | |
| } | | |

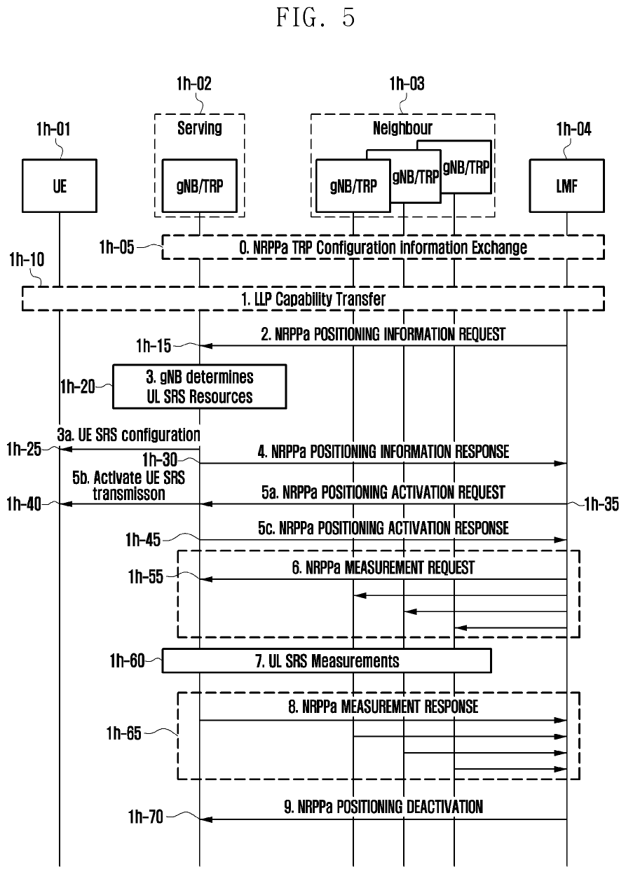

FIG. 5 is a flowchart illustrating a detailed message exchange process for configuring a sounding reference signal (SRS) resource of the UE 1h-01 during operation of the UL positioning method (e.g., UL-TDOA and UL-AOA) and the DL+UL positioning method (e.g., Multi-RTT) according to an embodiment of the disclosure.

Referring to FIG. 5, a process in which the LMF 1h-04 configures a sounding reference signal (SRS) required for the UE 1h-01 to perform the UL/DL+UL positioning method operation is illustrated. The usage and definition of each message sent and received in each stage are as follows.

0. NRPPa TRP Configuration Information Exchange 1h-05

: Illustrates a procedure for securing a process for obtaining information (e.g., NR cell information, PRS configuration, spatial direction information, location information, etc.) required for the LMF 1h-04 to perform the UL positioning method from serving gNB/TRP 1h-02 and neighbor gNB/TRP 1h-03.

1. LPP Capability Transfer 1h-10

: Illustrates a procedure in which LMF 1h-04 requests capability information of a terminal related to location estimation and receives a response to and from UE 1h-01. The details are the same as the description of FIG. 4.

2. NRPPa POSITIONING INFORMATION REQUEST 1h-15

: Is an NRPPa message transmitted from LMF 1h-04 to determine the SRS transport resource configuration of the UE 1h-01 required for UL positioning based on previously collected information (e.g., location information of adjacent TRPs, existing location information of the UE, SSB/PRS transmission information of TRPs, etc.), and request the serving gNB 1h-02 for the determined SRS transmission resource configuration. The corresponding message includes the required number of SRS resources, periodicity, pathloss reference, spatial relation information, and the like.

3. gNB Determines UL SRS Resources 1h-20

: After receiving the NRPPa POSITIONING INFORMATION REQUEST message from LMF 1h-04, the serving gNB 1h-02 may finally determine the SRS resource to be configured to the UE 1h-01 based on the content of the message.

3a. UE SRS configuration 1h-25

: serving gNB 1h-02 delivers the SRS resource determined in process 3 to UE 1h-01 via RRC signaling.

4. NRPPa POSITIONING INFORMATION RESPONSE 1h-30

: Is an NPRRa message used by the serving gNB 1h-02 to deliver the SRS resource configuration information (e.g., the location on the time/frequency axis of the SRS resource, period, spatial relation information, etc.) finally delivered to the UE 1h-01 in in process 3 to the LMF 1h-04.

5a. NRPPa POSITIONING ACTIVATION REQUEST 1h-35

: Is an NRPPa message used by LMF 1h-04 to request SRS transmission activation of UE 1h-01 to serving gNB 1h-02 in a case where semi-persistent or aperiodic SRS is configured.

5b. Activate UE SRS transmission 1h-40

: Is a process in which the serving gNB 1h-02, having received the 5a message, instructs UE 1h-01 to activate SRS via MAC CE or DCI.

5c. NRPPA POSITIONING ACTIVATION RESPONSE 1h-45

: Is an NRPPa message used by the serving gNB 1h-02 to inform the LMF 1h-04 whether SRS activation has been completed in response to the 5a message.

6. NRPPa MEASUREMENT REQUEST 1h-55

: Is an NRPPa message delivered by the LMF 1h-04 to request SRS measurement and result report transmitted from the UE 1h-01 to the serving gNB/TRP 1h-02 and the neighboring gNB/TRP 1h-03. In this case, the SRS resource information configured to the UE 1h-01 may be included in the corresponding message.

7. UL SRS Measurements 1h-60

: The serving gNB/TRP 1h-02 and the neighboring gNB/TRP 1h-03 that have received a request for SRS measurement from the LMF 1h-04 via the message in process 6 above may measure SRS transmitted from the UE 1h-01 based on the SRS configuration information included in the corresponding message.

8. NRPPa MEASUREMENT RESPONSE 1h-65

: Is a transmitted NRPPa message for the serving gNB/TRP 1h-02 and the neighboring gNB/TRP 1h-03, that were requested to measure SRS from the LMF 1h-04 in process 6 above, to deliver measurement results to the LMF 1h-04.

9. NRPPa POSITIONING DEACTIVATION 1h-70

: Is an NRPPa message transmitted from the LMF 1h-04 to the serving gNB 1h-02 to deactivate the SRS transmission requested in process 5a above after the location estimation technique operation has been completed.

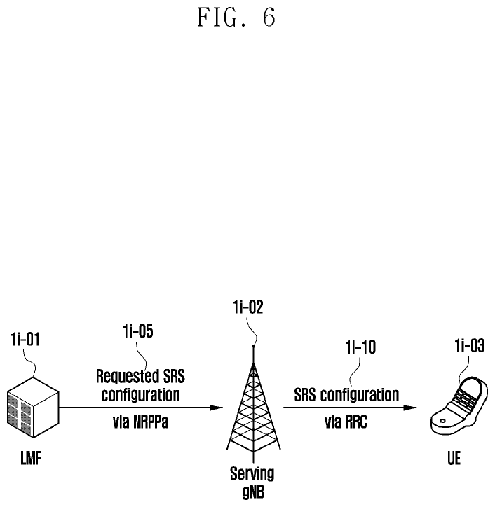

FIG. 6 is a diagram illustrating information delivered between an LMF, a serving gNB, and a UE for configuring transmission of a sounding reference signal (SRS) of the UE according to an embodiment of the disclosure.

Referring to FIG. 6, when SRS transmission of a UE 1i-03 is required, a process is illustrated in which the LMF 1i-01 delivers the SRS resource required for the location estimation technique operation to the serving gNB (1i-02) via NRPPa signaling, and the serving gNB 1i-02 finally determines the SRS resource to be configured to the UE 1i-03 based on the delivered SRS resource and delivers determined SRS resource via RRC signaling 1i-10.

Tables 6 and 7 below illustrate Requested SRS Transmission Characteristic IE (content corresponding to 1i-05 in FIG. 6) and Spatial Relation Information IE defined in the general NRPPa standard (TS 38.455), respectively.

TABLE 6

| | | | | Semantics |
|---|---|---|---|---|
| IE/Group Name | Presence | Range | IE Type and Reference | Description |
| Number Of | C- | | INTEGER | The number of |
| Periodic | ifResourceTypePeriodic | | (0 . . . 500, . . .) | periodic SRS |
| Transmissions | | | | transmissions |
| | | | | requested. The |
| | | | | value of ‘0’ |
| | | | | represents an |
| | | | | infinite number |
| | | | | of periodic SRS |
| | | | | transmissions. |
| Resource Type | M | | ENUMERATED | |
| | | | (periodic, semi- | |
| | | | persistent, aperiodic, . . .) | |
| CHOICE | M | | | |
| Bandwidth | | | | |
| >FR1 | | | ENUMERATED | |
| | | | (5 mHz, 10 mHz, 20 mHz, | |
| | | | 40 mHz, 50 mHz, | |
| | | | 80 mHz, 100 mHz, . . .) | |
| >FR2 | | | ENUMERATED | |
| | | | (50 mHz, 100 mHz, | |
| | | | 200 mHz, 400 mHz, . . .) | |
| SRS Resource | | 0 . . . 1 | | |
| Set List | | | | |
| >SRS Resource | | 1 . . . <maxnoSRS- | | |
| Set Item | | ResourceSets> | | |
| >>Number of | O | | INTEGER | The number of SRS |
| SRS Resources | | | (1 . . . 16, . . .) | Resources per |
| Per Set | | | | resource set for |
| | | | | SRS transmission. |
| >>Periodicity | | 0 . . . 1 | | |
| List | | | | |
| >>>Periodicity | | 1 . . . <maxnoSRS- | | |
| List Item | | ResourcePerSet> | | |
| >>>>PeriodicitySRS | M | | ENUMERATED | Milli-seconds |
| | | | (0.125, 0.25, 0.5, 0.625, | |
| | | | 1, 1.25, 2, 2.5, 4, 5, 8, | |
| | | | 10, 16, 20, 32, 40, 64, | |
| | | | 80, 160, 320, 640, 1280, | |
| | | | 2560, 5120, 10240, . . .) | |
| >>Spatial | O | | 9.2.34 | |
| Relation | | | | |
| Information | | | | |
| >>Pathloss | O | | 9.2.53 | |
| Reference | | | | |
| Information | | | | |
| SSB | O | | 9.2.54 | |
| Information | | | | |

TABLE 7

| | | | IE Type and | Semantics |
|---|---|---|---|---|
| IE/Group Name | Presence | Range | Reference | Description |
| Spatial Relation | | 1 . . . <maxnoSpatialRelations> | | According to TS |
| for Resource ID | | | | 38.321 [15] and |
| | | | | TS 38.331 [13] |
| CHOICE Reference | M | | | |
| Signal | | | | |
| >NZP CSI-RS | | | | |
| >>NZP CSI-RS | M | | INTEGER | |
| Resource ID | | | (0 . . . 191) | |
| >SSB | | | | |
| >> NR PCI | M | | INTEGER | |
| | | | (0 . . . 1007) | |
| >>SSB Index | O | | INTEGER | |
| | | | (0 . . . 63) | |
| >SRS | | | | |
| >>SRS Resource ID | M | | INTEGER | |
| | | | (0 . . . 63) | |
| >Positioning SRS | | | | |
| >> Positioning SRS | M | | INTEGER | |
| Resource ID | | | (0 . . . 63) | |
| >DL-PRS | | | | |
| >>DL-PRS ID | M | | INTEGER | |
| | | | (0 . . . 255) | |
| >>DL-PRS | M | | INTEGER | |
| Resource Set ID | | | (0 . . . 7) | |
| >>DL-PRS | O | | INTEGER | |
| Resource ID | | | (0 . . . 63) | |

Table 8 below illustrates contents of the spatial relation information defined in Table 7 in the form of ASN.1 code. Via Table 8 below, it may be seen that up to maxnoSpatialRelations (=64) spatial relation for resource ID IEs may be sequentially included in spatial relation information IE, and one of NZP CSI-RS, SSB, SRS, positioning SRS, and DL-PRS type of reference signal may be selected and included in each spatial relation for resource ID IE.

TABLE 8

```
SpatialRelationInfo ::= SEQUENCE {
      spatialRelationforResourceID
      SpatialRelationforResourceID,
      iE-Extensions ProtocolExtensionContainer { {SpatialRelationInfo-ExtIEs}
} OPTIONAL,
      ...
}
SpatialRelationInfo-ExtIEs NRPPA-PROTOCOL-EXTENSION ::= {
      ...
}
SpatialRelationforResourceID ::= SEQUENCE (SIZE(1..maxnoSpatialRelations)) OF
SpatialRelationforResourceIDItem
SpatialRelationforResourceIDItem ::= SEQUENCE {
      referencesignal Referencesignal,
      iE-Extensions ProtocolExtensionContainer {
{SpatialRelationforResourceIDItem-ExtIEs} } OPTIONAL,
      ...
}
...
Referencesignal ::= CHOICE {
      nZP-CSI-RS  NZP-CSI-RS-
ResourceID,
      sSB  SSB,
      sRS
      SRSResourceID,
      positioningSRS
      SRSPosResourceID,
      dL-PRS  DL-
PRS,
      choice-Extension  ProtocolIE-Single-Container
{{ReferenceSignal-ExtensionIE }}
}
```

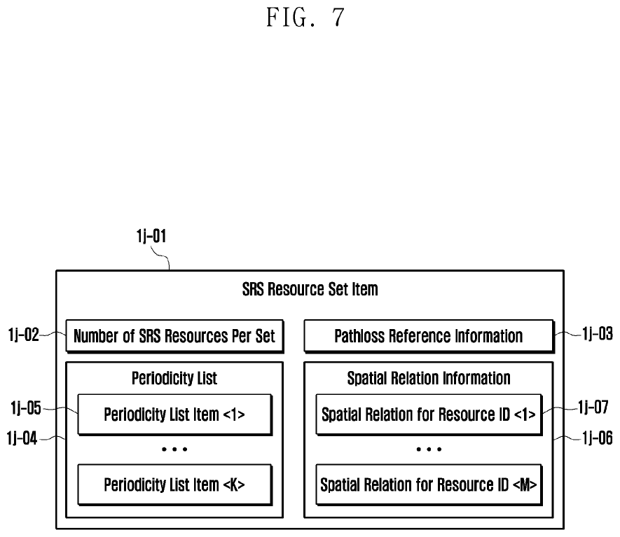

FIG. 7 is a diagram briefly illustrating SRS-related request configuration information included in the Requested SRS configuration delivered by a LN F to a serving gNB in FIG. 6 according to an embodiment of the disclosure.

Referring to FIG. 7, the number of SRS resources required for each SRS resource set, which is a bundle of activation/deactivation units when requesting SRS resources set 1j-02, information for pathloss estimation 1j-03, period information 1j-04, spatial relation information 1j-06, etc. may be included. A detailed description of each information is as follows.

Number of SRS resource per SRS resources set 1j-02

: The number of SRS resources requested to be set for each corresponding SRS resource set item 1j-01 may be included. It may be set to an integer value between 1 and 16.

Pathloss Reference Information (i.e., information for pathloss estimation 1j-03)

: Information required to determine the transmission signal strength when the UE transmits an SRS. Reference signal information transmitted by the gNB/TRP to which SRS is received via downlink may be included, and the UE may measure the corresponding Pathloss Reference to estimate degree of signal attenuation between the UE and the receiving gNB/TRP and reflect the degree in determining the SRS transmission signal strength.

Periodicity List (i.e., period information 1j-04)

: Includes requested SRS transmission period information. Up to maxnoSRS-ResourcePerSet (=16) periodicity list item 1j-05 may be included.

Spatial Relation Information 1j-06

: Information used to indicate beam direction information when the UE transmits an SRS. Up to maxnoSpatialRelations (=64) spatial relation for resource ID may be included, and one reference signal (e.g., one of the SSB, PRS, CSI-RS transmitted by the SRS reception target gNB/TRP via downlink, SRS previously configured by the serving gNB, etc.) serving as a reference for the direction of the SRS transmission beam may be configured in each spatial relation for resource ID. Finally, the serving gNB configures one spatial relation information for each SRS resource, and when the UE transmits SRS in the configured SRS resource, the serving gNB may determine the beam direction based on the corresponding spatial relation information. In a case where SSB, PRS, CSI-RS information transmitted by the receiving target TRP in downlink is indicated as spatial relation information, the UE may transmit the SRS by using the optimal beam reception filter selected when receiving the corresponding RS. In addition, if one of the SRS resources previously configured by the serving gNB is indicated as the spatial relation information, the newly configured SRS may be transmitted according to the beam direction of the corresponding preconfigured SRS resource.

In the current 3GPP Rel17, the serving gNB receives the SRS resource configuration request information from the LMF, and in the process of finally configuring the SRS resource to the UE, the agreement related to the spatial relation information determination is derived as illustrated in Table 9 below.

TABLE 9
Agreements:
Spatial relation of SRS is recommended by the LMF
and decided by the gNB. It is up to gNB
implementation whether to follow the LMF
recommendation. The gNB informs the LMF of its
decision.

Referring to Table 9 above, the LMF may recommend spatial relation information for the SRS requested resource, and based on this, the serving gNB may determine the spatial relation information of the SRS resource. The spatial relation recommendation information provided by the LMF to the serving gNB is the same as the spatial relation information 1j-06 of FIG. 7.

Referring again to FIG. 7 to take a closer look at the process in which the serving gNB determines the SRS resource and the corresponding spatial relation information, the serving gNB may be provided with information on the number of SRS resources required in units of SRS Resource Set 1j-02 N (<=16) and the number of spatial relation for resource ID 1j-07 M (<=64) that may be used in this case from LMF. However, in some cases, it may be difficult for the serving gNB to configure spatial relation information for each SRS resource due to an ambiguous correspondence between the M pieces of spatial relation information given from the LMF and the number of N SRS configuration requests. For example, assuming a situation of N<M, while configuring N SRS resources, the serving gNB should be determined based on N spatial relation information corresponding thereto. In this case, although the process of selecting N spatial relations out of M is left to the serving gNB's own implementation according to the current standard, the serving gNB does not have the information (for example, it may refer to existing location information of the UE that the LMF has, location information of gNB/TRPs, downlink SSB/PRS information transmitted by gNB/TRPs, etc.) required to configure an appropriate spatial relation, so it may be difficult for the serving gNB to appropriately select spatial relation information for each SRS resource based on the information given in the current standard.

Accordingly, the disclosure proposes a solution in two directions to clarify the correspondence between the SRS resource and spatial relation information, which are vaguely defined in the current NRPPa standard.

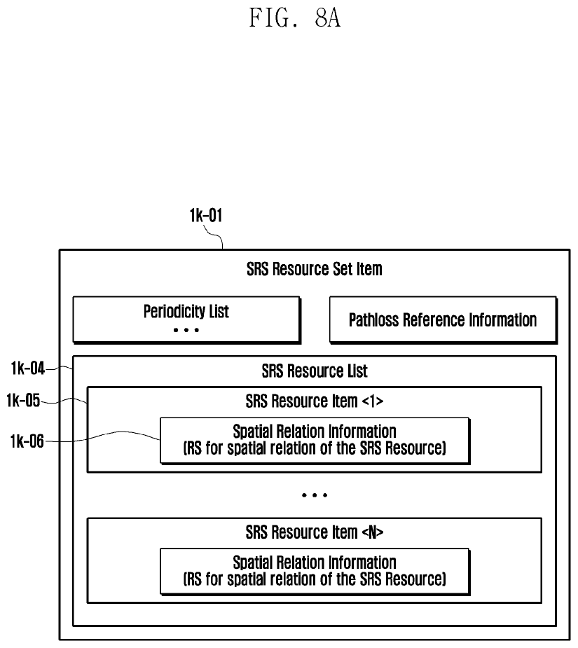

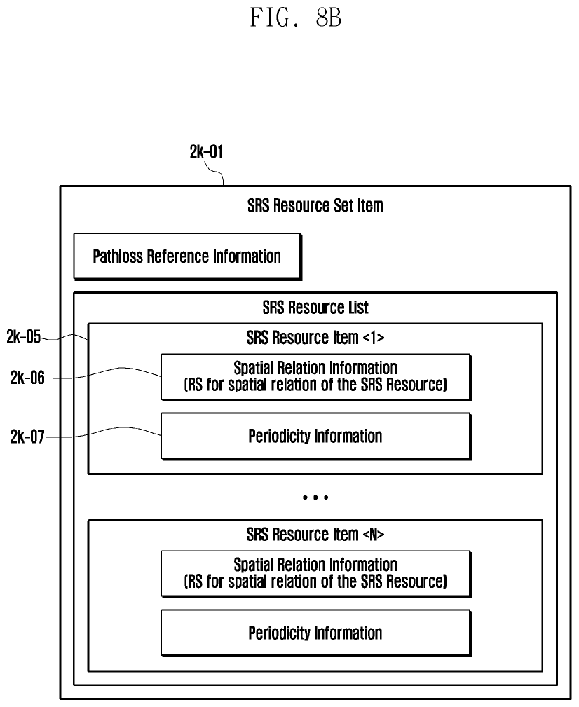

FIGS. 8A and 8B are diagrams illustrating an NRPPa standard proposal for supporting configuration of a single spatial relation per SRS resource unit according to an embodiment of the disclosure.

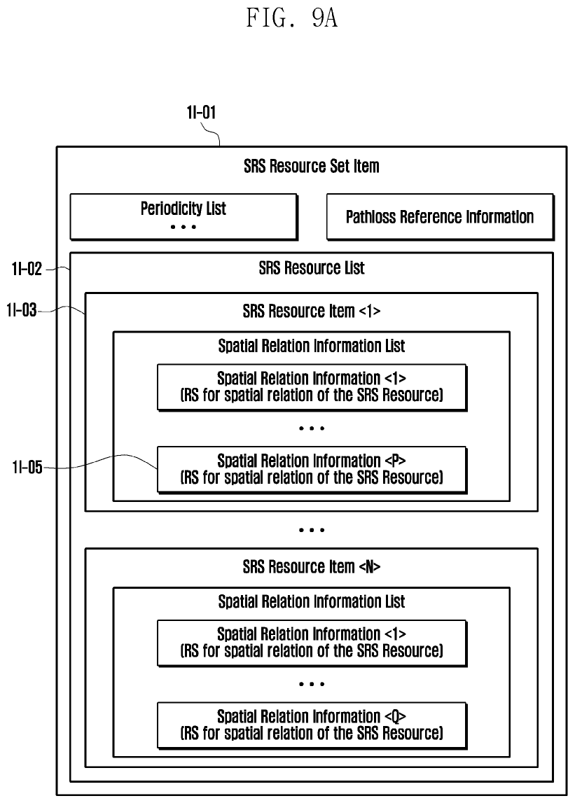

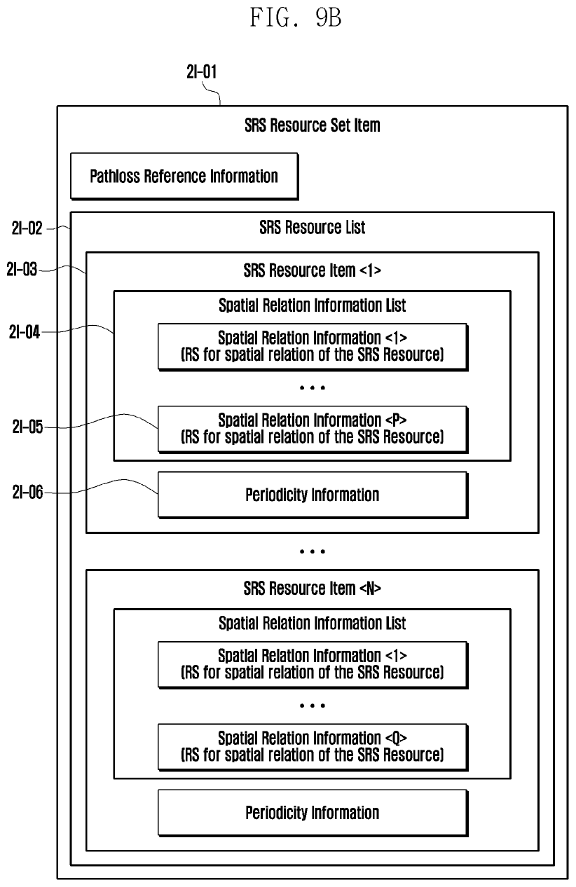

FIGS. 9A and 9B are diagrams illustrating an NRPPa standard proposal for supporting configuration of multiple spatial relation per SRS resource unit according to an embodiment of the disclosure.

The first method is to improve the current NRPPa standard, and improvement is possible in the following three directions.

1. Configure one spatial relation information (reference signal to indicate spatial relation) in units of SRS resources

: Defines the SRS resource list 1k-04 including N (<=16) SRS resource items 1k-05 again in the SRS resource set item 1k-01 as in FIG. 8A. In addition, it is possible to redefine the NRPPa standard to include one spatial relation information 1k-06 in each SRS Resource Item. In the example illustrated in FIG. 8A, a maximum of 16 periodicity information may be included in the SRS resource set item 1k-01 or 2k-01. As a modification to this, a method of including spatial relation information 2k-06 and periodicity information 2k-07 together in each SRS resource item 2k-05 as illustrated in FIG. 8B is also possible to be proposed.

Advantages and effects expected when using the proposed method are as follows.
As the LMF indicates one spatial relation information in units of SRS resources, the optimal beam direction information determined from the LMF's point of view may be delivered to the serving gNB.
The serving gNB may utilize the spatial relation information given for each SRS resource without additional computation, thereby reducing the gNB's computational complexity.

2. Configure multiple candidate spatial relation information in units of SRS resources

: Defines the SRS resource list 1l-02 including N (<=16) SRS resource items 1l-03 again in the SRS resource set item 1l-01 as in FIG. 9A, and it is possible to redefine the NRPPa standard to include maxnoSpatialRelations (=64) spatial relation information 1l-05 in each SRS resource item. In this case, LMF may make the correspondence between SRS resource and spatial relation information more clear by providing the serving gNB with information on a number of candidate spatial relations that may be used for one SRS resource, while providing candidate spatial relation information for each SRS resource unlike the existing one. As a modification to this, a method of including spatial relation information list 2l-04 and periodicity information 2l-06 together in each SRS resource item as illustrated in FIG. 9B is also possible to be proposed. In FIG. 9B, reference marks 2l-01, 2l-02 and 2l-03 are the same as li-1, 1i-02 and 1i-03 in FIG. 9A.

Advantages and effects expected when using the proposed method are as follows.
The LMF may deliver multiple spatial relation information candidates that may be configured in units of SRS Resources to the serving gNB.
The serving gNB may select the most appropriate information among the spatial relation information candidates delivered by the LMF in units of SRS resources based on internally secured information (for example, the RRM measurement result value received feedback from the UE may be considered.).

3. Addition of constraint to make the number of requested SRS resources equal to the number of given spatial relation information

: As illustrated in FIG. 7, one-to-one correspondence between SRS resources and given spatial relation information may be clarified by adding a constraint so that the number of requested SRS resources set 1j-02 N and the number of spatial relation for resource ID IE 1j-07 included in the spatial relation information IE 1j-06 M are always the same.

Advantages and effects expected when using the proposed method are as follows.
The change in the NRPPa standard may be minimized while having the same effect as the first proposed technique.
However, in a case where periodicity information is also considered, additional restrictions may be required so that the number of periodicity list items (K in FIG. 7) is also equal to the number N of the requested SRS resources.

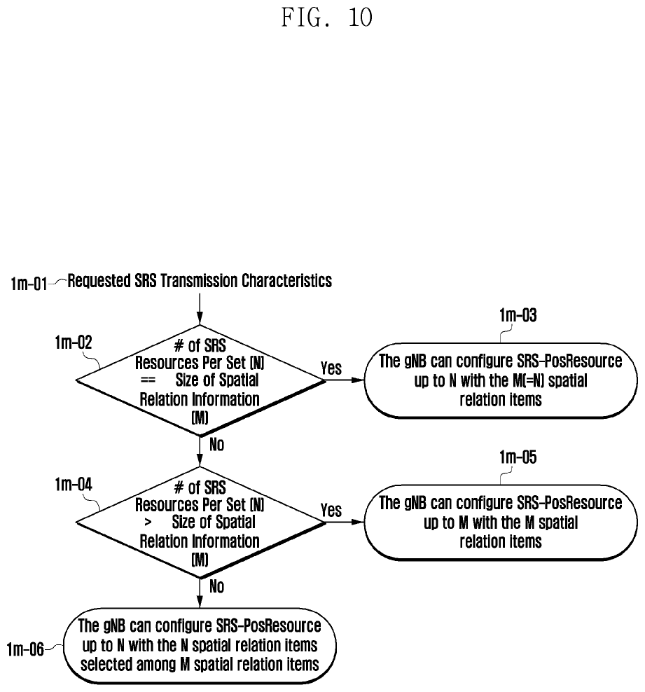

When the SRS resource request is given from the LMF in the format illustrated in FIG. 7 according to the current NRPPa standard definition, based on this information, the second method is to add a detailed operation description of how the serving gNB may determine the spatial relation information of each SRS resource to the specification. Possible example operations are as described in FIG. 10 below.

FIG. 10 is a flowchart illustrating a method for configuring spatial relation information when configuring an SRS resource of a serving gNB according to an embodiment of the disclosure.

Referring to FIG. 10, an embodiment of how the Serving gNB determines spatial relation information when configuring the SRS resource based on the requested SRS resource information 1m-01 provided from the LMF may be seen. In all cases provided below, the serving gNB may determine the number of configurable SRS resources by referring to capability information (for example, information such as SRS-AllPosResources-r16 IE in the RRC standard may be considered.) related to SRS configuration for positioning received from the UE. The detailed operation for each case may be defined as follows.

Case 1 (N=M) condition identification 1m-02

: In a case where the number of requested SRS resources (N) and the number of given spatial relation information (M) are the same, the serving gNB may configure up to N SRS resources corresponding to M (=N) pieces of spatial relation information as in 1m-03. As described above, by clarifying the operation contents of the gNB determining the correspondence of spatial relation information for each SRS resource, unnecessary operations at the gNB end may be reduced and the SRS configuration operation at the gNB end may be clarified.

Case 2 (N>M) condition identification 1m-04

: In a case where the number of requested SRS resources (N) is larger than the number of given spatial relation information (M), the serving gNB may configure up to M SRS resources corresponding to M pieces of spatial relation information as in 1m-05. As described above case, in a case where the number M of the given spatial relation information is less than the number N of the requested SRS resources, when the gNB configures N SRS resources, inevitably, multiple SRS resources with redundant spatial relation information may be allocated, and SRS resources may be wasted unnecessarily. Accordingly, in this case, by defining the gNB to allocate only M SRS resources as in the proposed operation, unnecessary operation and waste of SRS resources at the gNB end may be prevented.

Case 3 (N<M) condition identification 1m-04

: In a case where the number of requested SRS resources (N) is less than the number of given spatial relation information (M), the serving gNB may select N pieces among M pieces of spatial relation information as illustrated in 1m-06 and configure a maximum of N SRS resources corresponding thereto. In this case, a method of selecting N pieces among M pieces of spatial relation information may be one of the following methods.
Random selection of N among M spatial relation information

: In a case where there is no additional information necessary to select the appropriate N among the M spatial relations given in the serving gNB, N may be arbitrarily selected. In addition, based on this, it is possible to configure maximum of N SRS resources. As described above, in a case where N is randomly selected among M spatial relations, it is possible to reduce the operation at the gNB end, but there is a possibility that the optimal spatial relation may not be selected.
Optimal selection of N among M spatial relation information by using additional information available at the serving gNB end

: In a case where there is additional information (as an example, the SSB measurement result obtained via the UE's RRM result report may be considered.) that may be utilized to select the optimal spatial relation information required for UE location estimation in the serving gNB, based on this, it is possible to select N optimal among M spatial relations. In addition, based on this, a maximum of N SRS resources may be configured. As described above, in a case of selecting N among M spatial relations based on additional information previously secured by the gNB, the optimal spatial relation may be selected based on the actual channel condition of the UE.
The M pieces of spatial relation information are arranged and provided in the order of priority determined by the LMF, and the Serving gNB may select N pieces according to the priority. In addition, based on this, a maximum of N SRS resources may be configured. As described above, in a case where the spatial relation information is sorted and sent according to the priority determined by the LMF, the gNB may select the optimal spatial relation technique for each SRS resource by using not only the channel information collected by itself but also the priority information provided by the LMF.

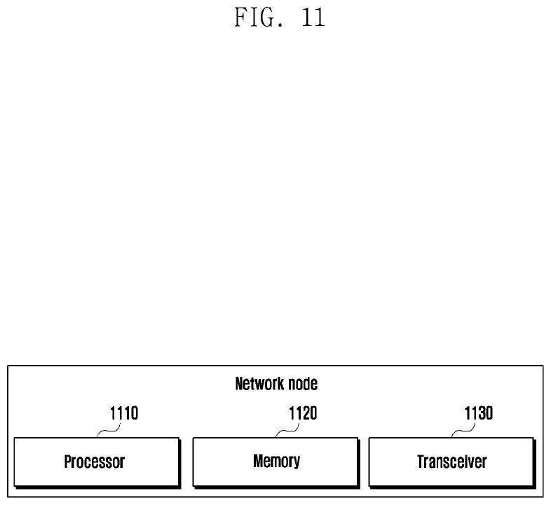

FIG. 11 illustrates a configuration of a network node according to an embodiment of the disclosure.

Referring to FIG. 11, the network node may include a processor 1110, a memory 1120, and a transceiver 1130. According to an embodiment, the network node may be a device in which at least one of network functions (NF) of a core network (CN) is implemented. According to an embodiment, the network node may correspond to the above-described location management function (LMF).

The processor 1110 may control the overall operation of the network node. For example, the processor 1110 may transmit and receive signals via the transceiver 1130. In addition, the processor 1110 may write and read data to and from the memory 1120. In addition, the processor 1110 may perform functions of a protocol stack required by a communication standard. To this end, the processor 1110 may include at least one processor. In addition, the processor 1110 may control the network node to perform operations according to the above-described embodiments.

The memory 1120 may store data such as a basic program, an application program, and configuration information for the operation of the network node. The memory 1120 may be configured as a volatile memory, a non-volatile memory, or a combination of a volatile memory and a non-volatile memory. In addition, the memory 1120 may provide stored data according to the request of the processor 1110.

The transceiver 1130 may perform functions for transmitting and receiving signals via a wired channel or a wireless channel. For example, the transceiver 1130 may perform a conversion function between a baseband signal and a bit stream according to a physical layer standard of a system. For example, when transmitting data, the transceiver 1130 may generate complex symbols by encoding and modulating the transmission bit stream. In addition, when receiving data, the transceiver 1130 may restore the baseband signal to a received bit stream via demodulation and decoding. In addition, the transceiver 1130 may up-convert a baseband signal into a radio frequency (RF) band signal, transmit the same via an antenna, and down-convert an RF band signal received via the antenna into a baseband signal. To this end, the transceiver 1130 may include a transmission filter, a reception filter, an amplifier, a mixer, an oscillator, a digital-to-analog converter (DAC), an analog-to-digital converter (ADC), and the like. In addition, the transceiver 1130 may include an antenna unit. The transceiver 1130 may include at least one antenna array including a plurality of antenna elements. In terms of hardware, the transceiver 1130 may include digital and analog circuits (e.g., a radio frequency integrated circuit (RFIC)). The digital and analog circuits may be implemented as one package. In addition, the transceiver 1130 may include multiple RF chains. In addition, the transceiver 1130 may transmit and receive a signal. To this end, the transceiver 1130 may include at least one transceiver.

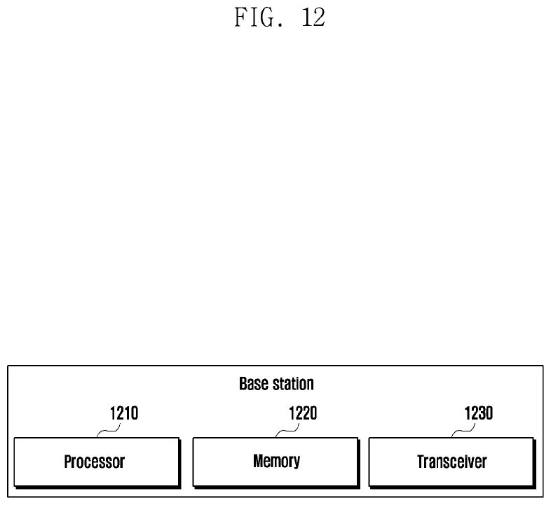

FIG. 12 illustrates a configuration of a base station according to an embodiment of the disclosure.

Referring to FIG. 12, the base station may include a processor 1210, a memory 1220, and a transceiver 1230.

According to an embodiment, the base station may be implemented as a distributed deployment according to a centralized unit (CU) and a distributed unit (DU). The CU may be configured to be connected to one or more DUs to perform a function of an upper layer (for example, at least one of service data adaptation protocol (SDAP), packet data convergence protocol (PDCP), or radio resource control (RRC)) of an access network (AN). The DU may be configured to perform the function of the lower layer (for example, at least one of radio link control (RLC), medium access control (MAC), or physical (PHY)) of the access network. In this case, the interface between the CU and the DU may be referred to as an F1 interface.

The processor 1210 may control the overall operation of the base station. For example, the processor 1210 may transmit and receive signals via the transceiver 1230. In addition, the processor 1210 may perform functions of a protocol stack required by a communication standard. To this end, the processor 1210 may include at least one processor. In addition, the processor 1210 may control the base station to perform operations according to the above-described embodiments.

The memory 1220 may store data such as a basic program, an application program, and configuration information for the operation of the base station. The memory 1220 may be configured as a volatile memory, a non-volatile memory, or a combination of a volatile memory and a non-volatile memory. The memory 1220 may provide stored data according to the request of the processor 1210.

The transceiver 1230 may perform functions for transmitting and receiving signals via a wired channel or a wireless channel. For example, the transceiver 1230 may perform a conversion function between a baseband signal and a bit stream according to a physical layer standard of a system. For example, when transmitting data, the transceiver 1230 may generate complex symbols by encoding and modulating the transmission bit stream. In addition, when receiving data, the transceiver 1230 may restore the baseband signal to a received bit stream via demodulation and decoding. In addition, the transceiver 1230 may up-convert a baseband signal into a radio frequency (RF) band signal, transmit the same via an antenna, and down-convert an RF band signal received via the antenna into a baseband signal. To this end, the transceiver 1230 may include a transmission filter, a reception filter, an amplifier, a mixer, an oscillator, a digital-to-analog converter (DAC), an analog-to-digital converter (ADC), and the like. In addition, the transceiver 1230 may include an antenna unit. The transceiver 1230 may include at least one antenna array including a plurality of antenna elements. In terms of hardware, the transceiver 1230 may include digital and analog circuits (e.g., a radio frequency integrated circuit (RFIC)). The digital and analog circuits may be implemented as one package. In addition, the transceiver 1230 may include multiple RF chains. In addition, the transceiver 1230 may transmit and receive a signal. To this end, the transceiver 1230 may include at least one transceiver.

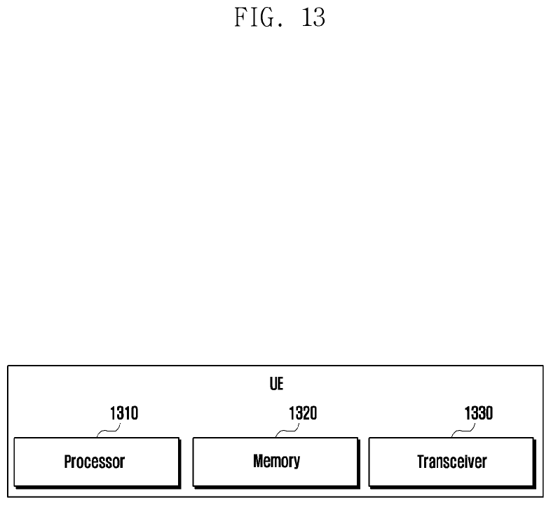

FIG. 13 illustrates a configuration of a terminal according to an embodiment of the disclosure.

Referring to FIG. 13, the UE may include a processor 1310, a memory 1320, and a transceiver 1330.

The processor 1310 may control the overall operation of the terminal. For example, the processor 1310 may transmit and receive signals via the transceiver 1330. In addition, the processor 1310 may perform functions of a protocol stack required by a communication standard. To this end, the processor 1310 may include at least one processor. In addition, the processor 1310 may control the terminal to perform operations according to the above-described embodiments.

The memory 1320 may store data such as a basic program, an application program, and configuration information for the operation of the terminal. The memory 1320 may be configured as a volatile memory, a non-volatile memory, or a combination of a volatile memory and a non-volatile memory. The memory 1320 may provide stored data according to the request of the processor 1310.

The transceiver 1330 may perform functions for transmitting and receiving signals via a wired channel or a wireless channel. For example, the transceiver 1330 may perform a conversion function between a baseband signal and a bit stream according to a physical layer standard of a system. For example, when transmitting data, the transceiver 1330 may generate complex symbols by encoding and modulating the transmission bit stream. In addition, when receiving data, the transceiver 1330 may restore the baseband signal to a received bit stream via demodulation and decoding. In addition, the transceiver 1330 may up-convert a baseband signal into a radio frequency (RF) band signal, transmit the same via an antenna, and down-convert an RF band signal received via the antenna into a baseband signal. To this end, the transceiver 1330 may include a transmission filter, a reception filter, an amplifier, a mixer, an oscillator, a digital-to-analog converter (DAC), an analog-to-digital converter (ADC), and the like. In addition, the transceiver 1330 may include an antenna unit. The transceiver 1330 may include at least one antenna array including a plurality of antenna elements. In terms of hardware, the transceiver 1330 may include digital and analog circuits (e.g., a radio frequency integrated circuit (RFIC)). The digital and analog circuits may be implemented as one package. In addition, the transceiver 1330 may include multiple RF chains. In addition, the transceiver 1330 may transmit and receive a signal. To this end, the transceiver 1330 may include at least one transceiver.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method by a location management function (LMF) entity, the method comprising:
identifying spatial relation information per a sounding reference signal (SRS) resource;
transmitting, to a base station, a request message for a positioning including information on the SRS resource, wherein the information on the SRS resource includes the identified spatial relation information per the SRS resource; and
receiving, from the base station, a response message including SRS resource configuration information determined based on the request message for the positioning.

2. The method of claim 1, wherein the request message for the positioning includes a list of information for a plurality of SRS resources.

3. The method of claim 2, wherein the list of information for the plurality of SRS resources respectively includes spatial relation information corresponding to each SRS resource of the plurality of SRS resources.

4. The method of claim 2, wherein a maximum number of the plurality of SRS resources included in the list of information is 16.

5. The method of claim 2, further comprising:
identifying periodicity information per the SRS resource,
wherein the request message for the positioning further includes the identified periodicity information, and
wherein a number of the periodicity information corresponds to a number of the plurality of SRS resources included in the list of the information for the plurality of SRS resources.

6. The method of claim 2, further comprising:
identifying periodicity information per the SRS resource,
wherein the list of information for the plurality of SRS resources respectively includes the periodicity information corresponding to each SRS resources.

7. The method of claim 1, wherein the spatial relation information per the SRS resource included in the information on the SRS resource indicates a corresponding uplink (UL) reference signal (RS) or downlink (DL) RS.

8. A method by a base station, the method comprising:
receiving, from a location management function (LMF) entity, a request message for a positioning including information on a sounding reference signal (SRS) resource, wherein the information on the SRS resource includes spatial relation information per the SRS resource, and the spatial relation information is identified per the SRS resource; and
transmitting, to the LMF entity, a response message including SRS resource configuration information determined based on the request message for the positioning.

9. The method of claim 8, wherein the request message for the positioning includes a list of information for a plurality of SRS resources.

10. The method of claim 9,
wherein the list of information for the plurality of SRS resources respectively includes spatial relation information corresponding to each SRS resource of the plurality of SRS resources,
wherein a maximum number of the plurality of SRS resources included in the list of information is 16,
wherein the request message for the positioning further includes periodicity information per the SRS resource, and
wherein a number of the periodicity information corresponds to a number of the plurality of SRS resources included in the list of the information for the plurality of SRS resources.

11. A location management function (LMF) entity, the LMF entity comprising:
a transceiver; and
at least one processor configured to:
identify spatial relation information per a sounding reference signal (SRS) resource,
transmit, to a base station via the transceiver, a request message for a positioning including information on the SRS resource, wherein the information on the SRS resource includes the identified spatial relation information per the SRS resource, and
receive, from the base station via the transceiver, a response message including SRS resource configuration information determined based on the request message for the positioning.

12. The LMF entity of claim 11, wherein the request message for the positioning includes a list of information for a plurality of SRS resources.

13. The LMF entity of claim 12, wherein the list of information for the plurality of SRS resources respectively includes spatial relation information corresponding to each SRS resource of the plurality of SRS resources.

14. The LMF entity of claim 12, wherein a maximum number of the plurality of SRS resources included in the list of information is 16.

15. The LMF entity of claim 12,
wherein the at least one processor is further configured to:
identify periodicity information per the SRS resource,
wherein the request message for the positioning further includes the identified periodicity information, and
wherein a number of the periodicity information corresponds to a number of the plurality of SRS resources included in the list of the information for the plurality of SRS resources.

16. The LMF entity of claim 12,
wherein the at least one processor is further configured to:
identify periodicity information per the SRS resource, and
wherein the list of information for the plurality of SRS resources respectively includes the periodicity information corresponding to each SRS resources.

17. The LMF entity of claim 11, wherein the spatial relation information per the SRS resource included in the information on the SRS resource indicates a corresponding uplink (UL) reference signal (RS) or downlink (DL) RS.

18. A base station comprising:
a transceiver; and
at least one processor configured to:
receive, from a location management function (LMF) entity via the transceiver, a request message for a positioning including information on a sounding reference signal (SRS) resource, wherein the information on the SRS resource includes spatial relation information per the SRS resource, and the spatial relation information is identified per the SRS resource, and
transmit, to the LMF entity via the transceiver, a response message including SRS resource configuration information determined based on the request message for the positioning.

19. The base station of claim 18, wherein the request message for the positioning includes a list of information for a plurality of SRS resources.

20. The base station of claim 19,
wherein the list of information for the plurality of SRS resources respectively includes spatial relation information corresponding to each SRS resource of the plurality of SRS resources,
wherein a maximum number of the plurality of SRS resources included in the list of information is 16,
wherein the request message for the positioning further includes periodicity information per the SRS resource, and
wherein a number of the periodicity information corresponds to a number of the plurality of SRS resources included in the list of the information for the plurality of SRS resources.
